(19) United States
(12) Patent Application Publication
(10) Pub. No.: US 2011/0108382 A1
(43) Pub. Date: May 12, 2011

(54) ONE-WAY CLUTCH AND METHOD OF ASSEMBLING SUCH CLUTCH

(76) Inventors: Seiichi Takada, Kuwana (JP); Hiroyoshi Ito, Kuwana (JP); Chiyori Satou, Kuwana (JP)

(21) Appl. No.: 13/002,528

(22) PCT Filed: Jun. 29, 2009
(86) PCT No.: PCT/JP2009/061836

§ 371 Date: Jan. 4, 2011

(30) Foreign Application Priority Data
Jul. 9, 2008 (JP) 2008-179201
Oct. 30, 2008 (JP) 2008-279105

(51) Int. Cl. F16D 41/066; B23P 11/00

(52) U.S. Cl. 192/45; 29/428

(57) ABSTRACT

The object is to stably support pillars forming a retainer of the roller type one-way clutch. An outer race (11) has one end thereof closed by a flange (16) and the other end closed by a lid (22). A predetermined number of pocket bottom surfaces (17) are continuously formed on the radially inner surface of the outer race (11). A pocket (24) is defined by pillars (23) inserted on both circumferential sides of each pocket bottom surface (17). The pillars (23) have their base portions integrally joined to the lid (22), thereby forming a retainer (12). The pillars (23) have protrusions (32) at their distal ends which are fixed to holes (19) formed in the flange (16) by e.g. fusing, thereby fixing the retainer (12) to the outer race (11).

### TECHNICAL FIELD

This invention relates to a one-way clutch used in a driving portion of an office machine, and a method of assembling such a clutch.

### BACKGROUND ART

A one-way clutch used e.g. in a driving portion of an office machine ordinarily includes rollers received in a plurality of pockets defined by cam surfaces formed on the radially inner surface of an outer race, and biasing springs also received in the respective pockets for biasing the rollers toward the narrow ends of the respective pockets. It is known to integrally form the biasing springs to reduce the number of parts and the number of assembling steps (see Patent document 1).

The one-way clutch disclosed in Patent document 1 comprises the outer race, the rollers received in the pockets formed on the radially inner surface of the outer race, the integrally formed biasing spring, a casing (outer member) in which the assembly of these parts is received, and an annular lid closing an open end of the casing. The biasing spring comprises an annular base portion and spring pieces formed by cutting and raising the peripheral edge portion of the annular base portion arranged at intervals corresponding to the intervals of the pockets. The spring pieces are inserted in the respective pockets.

The casing prevents separation of the clutch elements comprising the outer race, rollers and biasing spring by retaining them in the assembled state in the casing. With the clutch elements retained therein, the casing is mounted in a driving device and the clutch is driven by an external force. The lid is fitted in the radially inner surface of the casing at its open end.

This one-way clutch has an advantage that since an integral biasing spring is used, the number of parts and the number of assembling steps are both small, compared to a clutch including a plurality of biasing springs separately received in the respective pockets. But this clutch has a problem that since the plurality of pockets formed on the radially inner surface of the outer race are complicated in sectional shape and thus it is difficult to form such pockets.

To avoid this problem, it is known to form the radially inner surface of the outer race in a simple shape such that pocket bottom surfaces including cam surfaces of the pockets are continuously formed, and pillars are inserted at both circumferential ends of each pocket bottom surface to define a predetermined number of pockets (see Patent document 2). The pillars have their respective base portions integrally joined to the inner surface of the above-mentioned lid to form a retainer.

The pillars of the retainer are inserted into the outer race from its one end until engaging protrusions provided at the distal ends of the respective pillars are engaged in engaging recesses formed in the outer race at the other end thereof, thereby integrally joining the retainer to the outer race. The lid is fitted in the radially inner surface of the casing at its open end portion as with the above-mentioned arrangement.

Since the retainer is integrally joined to the outer race by fitting the engaging protrusions at the distal ends of the pillars in the respective engaging grooves of the outer race, the pillars tend to move relative to the outer race due to gaps between the protrusions and the recesses.

A one-way clutch having no casing is also known. This clutch has an outer race and a lid (shield) made of a metal and the lid is fixed to the outer race by spot-welding it to an end surface of the outer race (Patent document 3).

### PRIOR ART DOCUMENTS

### Patent Documents

Patent document 1: JP Patent publication 9-89011A
Patent document 2: JP Patent publication 2006-162027A
Patent document 3: JP Patent publication 2000-356230A

### SUMMARY OF THE INVENTION

### Object of the Invention

In the case of Patent document 3, since the clutch elements are joined together without using the casing, the number of parts is small. But it has disadvantages that pockets are formed on the radially inner surface of the outer race and that the lid is directly spot-welded to the outer race.

Even if the arrangement of Patent document 2, in which the retainer comprises the lid and the pillars integrally joined to the lid, is employed in the clutch of Patent document 3 in an attempt to omit the pockets of the outer race, since the retainer of Patent document 2 is joined to the outer race by fitting the engaging protrusions at the distal ends of the pillars in the engaging recesses of the outer race, the pillars tend to move relative to the outer race due to gaps between the protrusions and recesses. Even if, as in Patent document 3, the lid is spot-welded to the outer race in an attempt to stabilize the pillars, it is still impossible to stably support the pillars themselves.

An object of the present invention is to use an integral biasing spring as disclosed in Patent document 1, integrally join the pillars to the lid as disclosed in Patent document 2, omit the casing as in Patent document 3, and further to stably support the pillars, which are integrally joined to the lid to form a retainer.

### Means to Achieve the Object

In order to achieve this object, the present invention provides a one-way clutch comprising an outer race having a plurality of pockets formed on a radially inner surface of the outer race, rollers received in the respective pockets, a biasing spring biasing the rollers, closing means closing open ends of the outer race, and a shaft extending through the center of the outer race, wherein each pocket has a pocket bottom surface including a cam surface, and wherein the wedge-shaped spaces having a predetermined wedge angle δ are defined between the respective pocket bottom surfaces and the shaft, the rollers being biased by the biasing spring toward the narrow ends of the respective wedge-shaped spaces, wherein the closing means comprising a flange radially inwardly extending from one end of the outer race, and a lid provided at the other end of the outer race, wherein each of the pockets is defined by the pocket bottom surface and pillars inserted in the outer race on the respective circumferential sides of the pocket bottom surface, wherein the pillars have base portions integrally joined to the lid, whereby the pillars and the lid form a retainer, and wherein the retainer is fixed to the outer race by fixing distal ends of the respective pillars to the flange. Means for fixing the distal ends of the pillars to the flange may comprise protrusions provided at the respective distal ends of the pillars which are inserted in and fixed to holes formed in the flange.

The present invention also provides a method of assembling the above-described one-way clutch, which comprises providing a pedestal having a tubular portion into which the outer race can be inserted, the tubular portion having ribs on its radially inner surface that are configured to be fitted in respective anti-rotation grooves formed on the radially outer surface of the outer race, inserting the outer race axially into the pedestal with the anti-rotation grooves of the outer race axially aligned with the respective ribs of the pedestal, and mounting the biasing spring, the rollers and the retainer into the outer race.

### Advantages of the Invention

Since the clutch elements of the one-way clutch according to this invention are stably assembled together without using a casing, and the distal ends of the pillars forming the retainer are fixed to the flange of the outer race, it is possible to stably support the pillars, which ensures stable operation of the clutch.

Also, according to the present invention, when assembling the one-way clutch, the outer race is inserted into the pedestal so as to be non-rotatable. Thus, the biasing spring, rollers and retainer can be easily mounted into the outer race.

### BRIEF DESCRIPTION OF THE DRAWINGS

FIG. 1 is a sectional view of Embodiment 1.

FIG. 2 is a sectional view taken along line II-II of FIG. 1.

FIG. 3(a) is a front view of an outer race of Embodiment 1; FIG. 3(b) is a front view of a biasing spring of Embodiment 1; and FIG. 3(c) is a front view of a retainer of Embodiment 1.

FIG. 4 is an exploded perspective view of Embodiment 1;

FIG. 5 is a perspective view of jig rod and a pedestal used in assembling Embodiment 1.

FIG. 6(a) is a sectional view showing the initial assembling step of Embodiment 1; and FIG. 6(b) is a sectional view taken along line VI-VI of FIG. 6(a).

FIG. 7(a) is a sectional view showing the assembling step following the assembling step of FIGS. 6(a) and 6(b); and FIG. 7(b) is a sectional view taken along line VII-VII of FIG. 7(a).

FIGS. 8(a) and 8(b) are partial enlarged views showing intermediate assembling steps of Embodiment 1.

FIG. 9 is a sectional view showing the assembling step following the assembling step of FIGS. 7(a) and 7(b).

### MODE FOR EMBODYING THE INVENTION

Now the one-way clutch according to the present invention and the method of assembling this clutch embodying the present invention are described with reference to the drawings.

### Embodiment 1

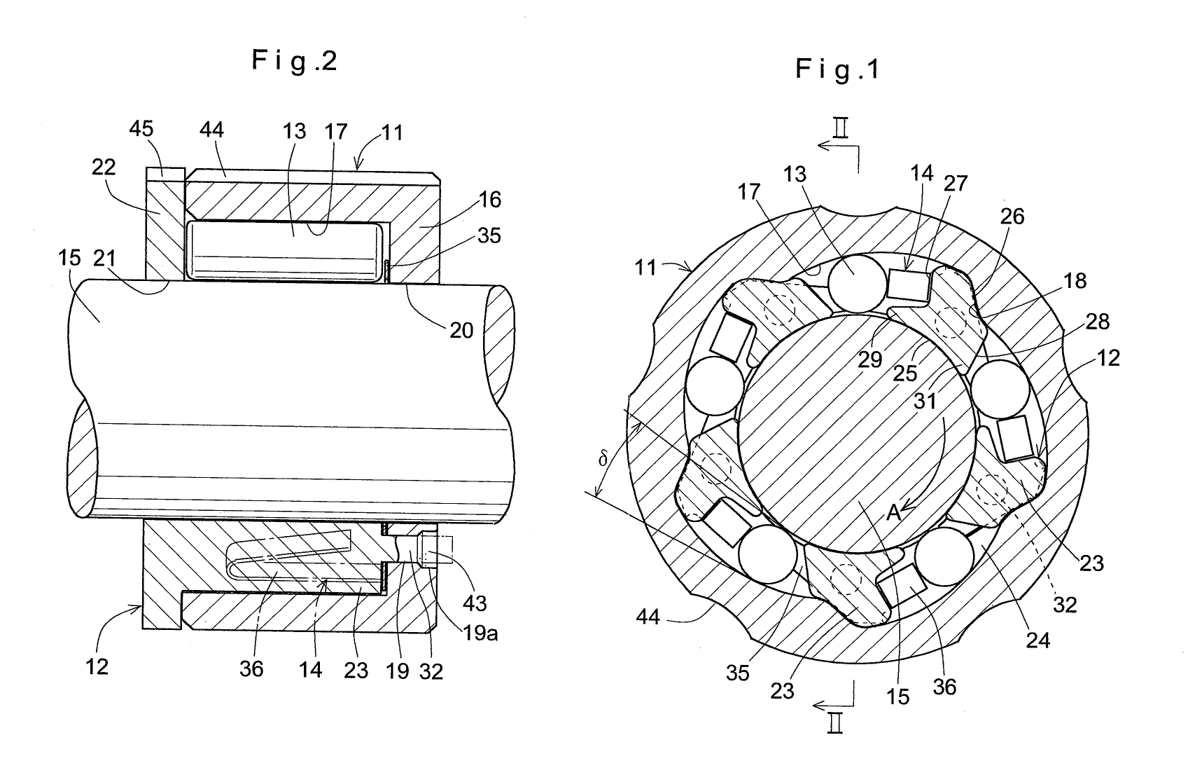

The one-way clutch of Embodiment 1, shown in FIGS. 1 to 9, comprises an outer race 11, a retainer 12, rollers 13, and a biasing spring 14. For use, a shaft 15 is inserted through the one-way clutch so as to extend along its central axis.

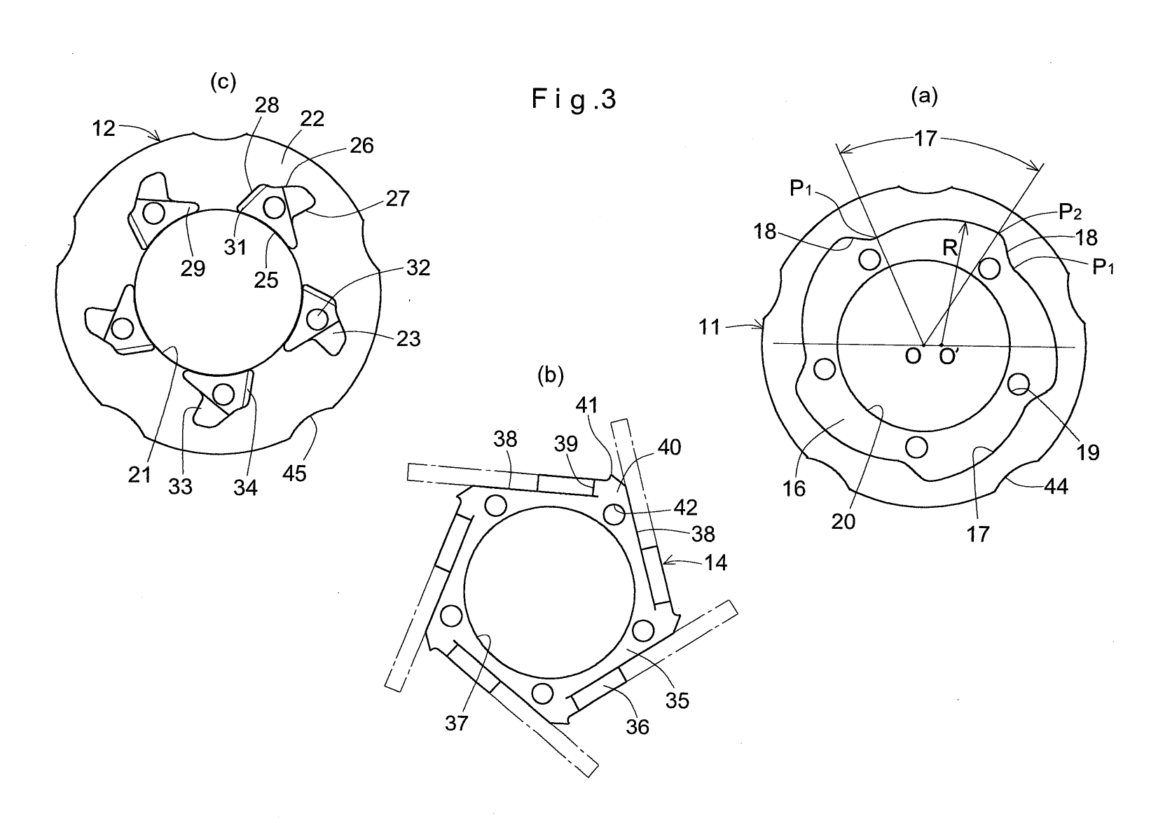

The outer race 11 is made of an oil-containing sintered alloy or a sintered alloy, and has two opposite open ends, one of which is closed by a radially inwardly extending flange 16 (see FIG. 2). Five pocket bottom surfaces 17 are formed on its radially inner surface at predetermined circumferential intervals over the entire circumference (see FIG. 3(a)).

Each pocket bottom surface 17 is defined by an eccentric arcuate surface extending from one of five circumferentially equidistantly spaced starting points P1 around the center O of the outer race to an end point P2 and having a radius R and a center O′ offset from the center O of the outer race. The distance between the center O of the outer race and the pocket bottom surface 17 gradually increases from the starting point P1 toward the end point P2.

The portion of each pocket bottom surfaces 17 extending from the starting point P1 to the end point P2 serves as a cam surface and also as a radial guide surface of the retainer 12. The radially inclined shoulder portion of each pocket bottom surface 17, which extends from the end point P2 to the starting point P1 of the adjacent pocket bottom surface 17, serves as a positioning portion 18 for positioning other parts (biasing spring 14 and retainer 12) when they are mounted.

The flange 16 has five holes 19 formed in its respective portions disposed between the positioning portions 18 and the radially inner surface 20. The holes 19 have an inner diameter which is slightly larger at its axially outer end portion than at its axially inner end portion (see FIG. 2).

The retainer 12 comprises an annular lid 22 and pillars 23 integrally provided on the inner surface of the lid 22. The lid 22 has an outer diameter that coincides with the outer diameter of the outer race 11 and has an inner diameter that coincides with the outer diameter of the shaft 15. The radially inner surface 21 of the lid 22 serves as a radial bearing for the shaft 15.

The pillars 23 are inserted into the outer race 11 so as to extend along the respective positioning portions 18 and thus circumferentially positioned. Five pockets 24 are defined each by one of the pocket bottom surfaces 17 and the pillars 23 on both sides thereof (see FIG. 1). The rollers 13 are each received in one of the five pockets 24.

As seen in cross-section, the pillars 23 have a length that coincides with the inner depth of the outer race 11 (see FIG. 2). As shown in FIGS. 1 and 3c, the pillars 23 each have a radially inner surface 25 extending along the radially inner surface 21 of the lid 22; a radially outer surface 26 that coincides with the enlarged end portion of the corresponding pocket bottom surface 17 and the positioning portion 18; an enlarged end surface 28 defining the enlarged side of the pocket 24; and a narrow end surface 28 circumferentially opposite to the end surface 27 and defining the narrow side of the adjacent pocket 24.

The boundary between the radially inner surface 25 and the enlarged end surface 27 of each pillar 23 protrudes obliquely radially inwardly and serves as a roller restricting portion 29. The boundary between the radially inner surface 25 and the narrow end surface 23 protrudes in the direction opposite to the protruding direction of the roller restricting portion 29, and serves as another roller restricting portion 31. Each roller restricting portion 29 of each pillar 23 is circumferentially opposed to and circumferentially spaced from the roller restricting portion 31 of the adjacent pillar 23 by a distance smaller than the diameter of the roller 13, thereby preventing separation of the roller 13 in the radially inward direction. The radially inner surfaces 25 of the pillars 23 serve as a radial bearing for the shaft 15.

Each pillar 23 has a protrusion 32 on its distal end surface that extends through the corresponding hole 19 such that its distal end slightly protrudes outwardly from the hole 19 (as shown by dot-chain line of FIG. 2).

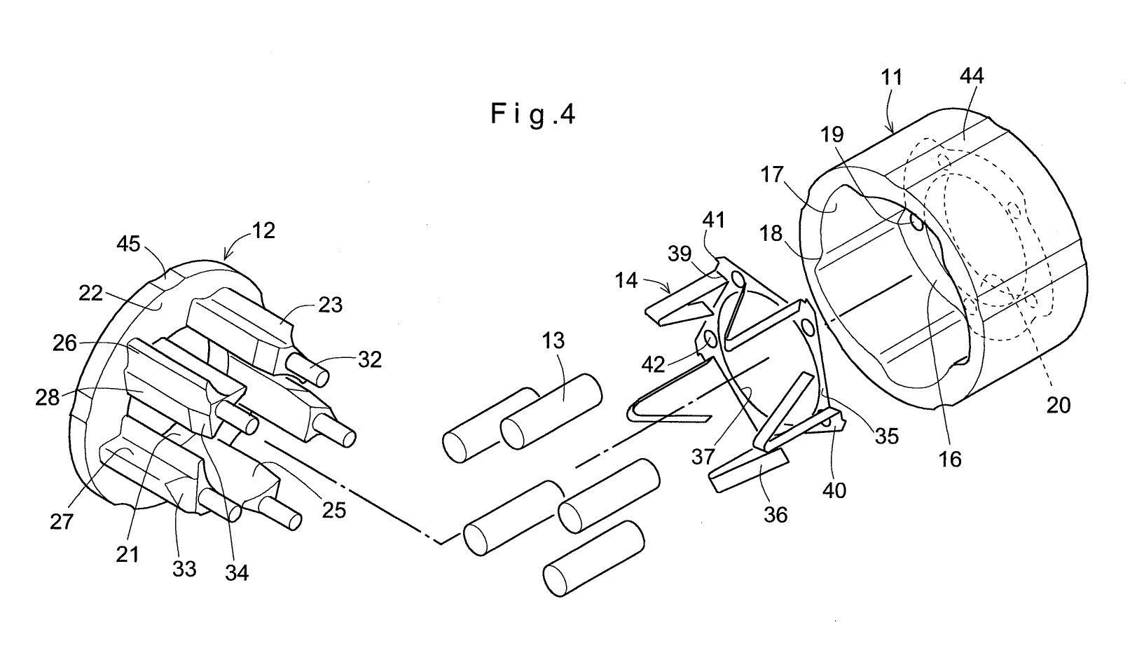

As shown in FIGS. 3(c) and 4, the distal end portion of the enlarged end surface 27 of each pillar 23 forms an inclined guide surface 33 inclined such that the pocket 24 expands toward its distal end, with its width decreasing toward its distal end. The distal end portion of the narrow end surface 28 forms another inclined guide surface 34 inclined such that the pocket 24 expands toward its distal end. For the reasons set forth below, the inclined guide surfaces 33 and 34 make it easier to mount the retainer 12 in the outer race 11.

The retainer 12 may be made of a thermoplastic resin for ease of injection molding, made of POM or PPS for higher oil resistance, or made of resin containing glass fiber or carbon fiber.

As shown in FIGS. 3(b) and 4, the biasing spring 14 comprises an annular portion 35 and spring pieces 36 which are formed from a single metal sheet. The annular portion 35 has a hole 37 into which the shaft 15 is inserted with a gap left therebetween. The spring pieces 36 are formed by cutting and raising the circumferentially equidistantly spaced apart outer peripheral portions of the annular portion 35 (shown by dot-chain line in FIG. 3(b).

Each spring piece 36 is separated from the annular portion 35 along a cut 38 parallel to a tangent line to the hole 37, and comprises a bent proximal end portion 39 bent at a right angle relative to the annular portion 35, and a distal end portion. At an intermediate portion, each spring piece 36 is bent into a V shape so that its distal end portion is located inward. Each bent proximal end portion 39 has a base portion 40 formed with a positioning protrusion 41 that contacts the guide surface portion of the corresponding pocket bottom surface 17 of the outer race 11 and further formed with a positioning hole 42.

The outer race has axial anti-rotation grooves 44 on its radially outer surface that are adapted to be axially aligned with respective anti-rotation grooves 45 formed in the radially outer surface of the lid 22 of the retainer when the clutch is assemble.

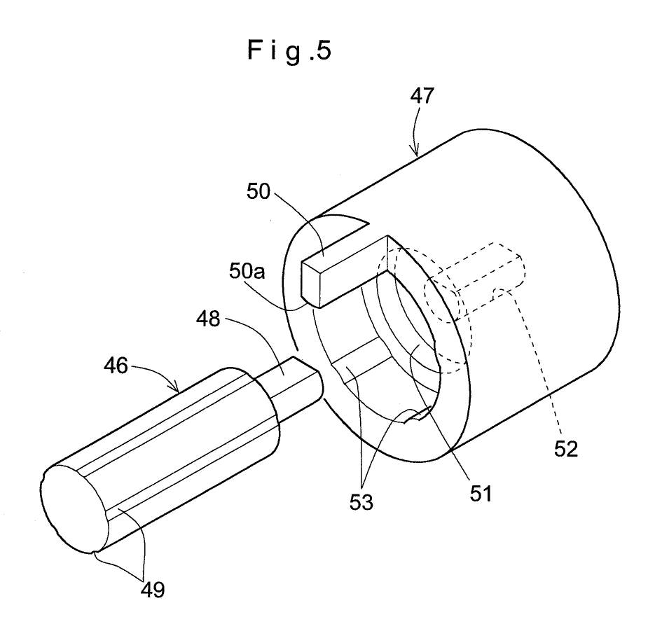

Now description is made of how the outer race, retainer 12, rollers 13 and biasing spring 14 are assembled into the one-way clutch of Embodiment 1. In assembling the clutch, a jig rod 46 and a pedestal 47 shown in FIG. 5 are used.

The jig rod 46 is a cylindrical member having a diameter substantially equal to the diameter of the shaft 15, and formed with an engaging portion 48 with a D-shaped cross-section at one end thereof. Also, the jig rod 46 has, on its radially outer surface, axial grooves 49 having a concave arcuate section with a radius of curvature equal to the radius of the rollers 13 at circumferential positions corresponding to positions of the respective rollers 13 when the rollers 13 are mounted in position.

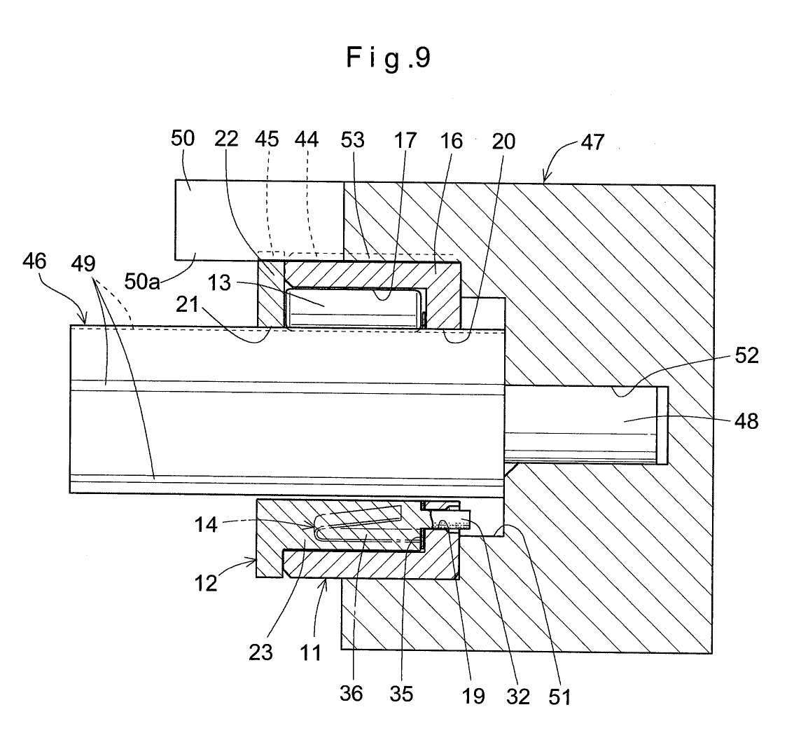

The pedestal 47 is a tubular member into which the outer race 11 can be inserted. The pedestal 47 has a bottom wall at one end of the tubular portion and a guide portion 50 axially extending from the end surface at its open end. The guide portion 50 axially guides the retainer 12 with its radially inner edge 50a engaged in one of the anti-rotation grooves 45 of the lid 22 of the retainer 12. The bottom wall of the pedestal has in its inner surface a small-diameter hole 51 in which the outer race cannot be inserted. Further, an axial engaging hole 52 having a D-shaped cross-section is formed in the bottom surface of the small-diameter hole 51. The engaging portion 48 of the jig rod 46 is engageable in the engaging hole 52. The tubular portion of the pedestal 47 has, on its radially inner surface, ribs 53 adapted to be engaged in the respective anti-rotation grooves 44 formed on the radially outer surface of the outer race 11. One of the ribs 53 is axially aligned with and contiguous with the radially inner edge 50a of the guide portion 50 (FIG. 9).

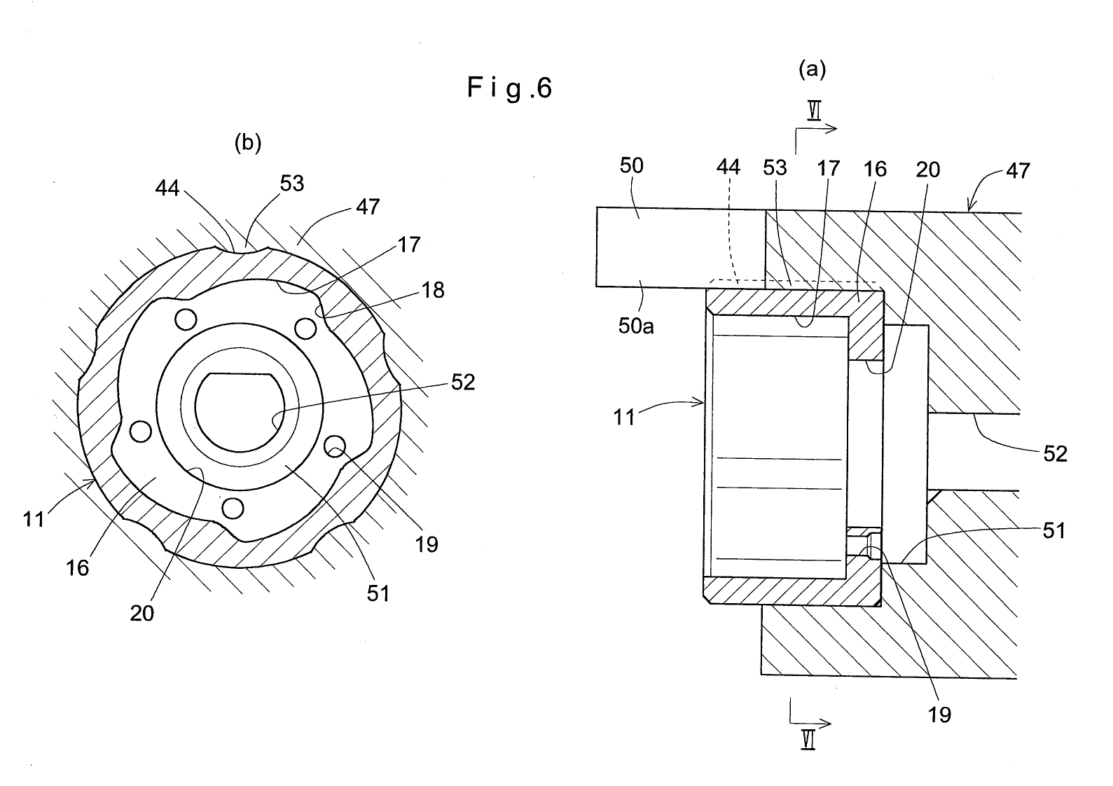

In assembling the one-way clutch using the jig rod 46 and the pedestal 47, as shown in FIGS. 6(a) and 6(b), the outer race 11 is first positioned relative to the pedestal 47 such that the radially inner edge 50a of the guide portion 50 of the pedestal 47 is engaged in one of the anti-rotation grooves 44 on the radially outer surface of the outer race 11, thereby axially aligning the anti-rotation grooves 44 with the respective ribs 53 of the pedestal 47: In this state, the outer race 11 is axially inserted into the pedestal 47. Since the outer race 11 is retained in position so as to be non-rotatable relative to the pedestal 47 in this state, the biasing spring 14, rollers 13 and retainer 12 can be easily mounted into the outer race 11.

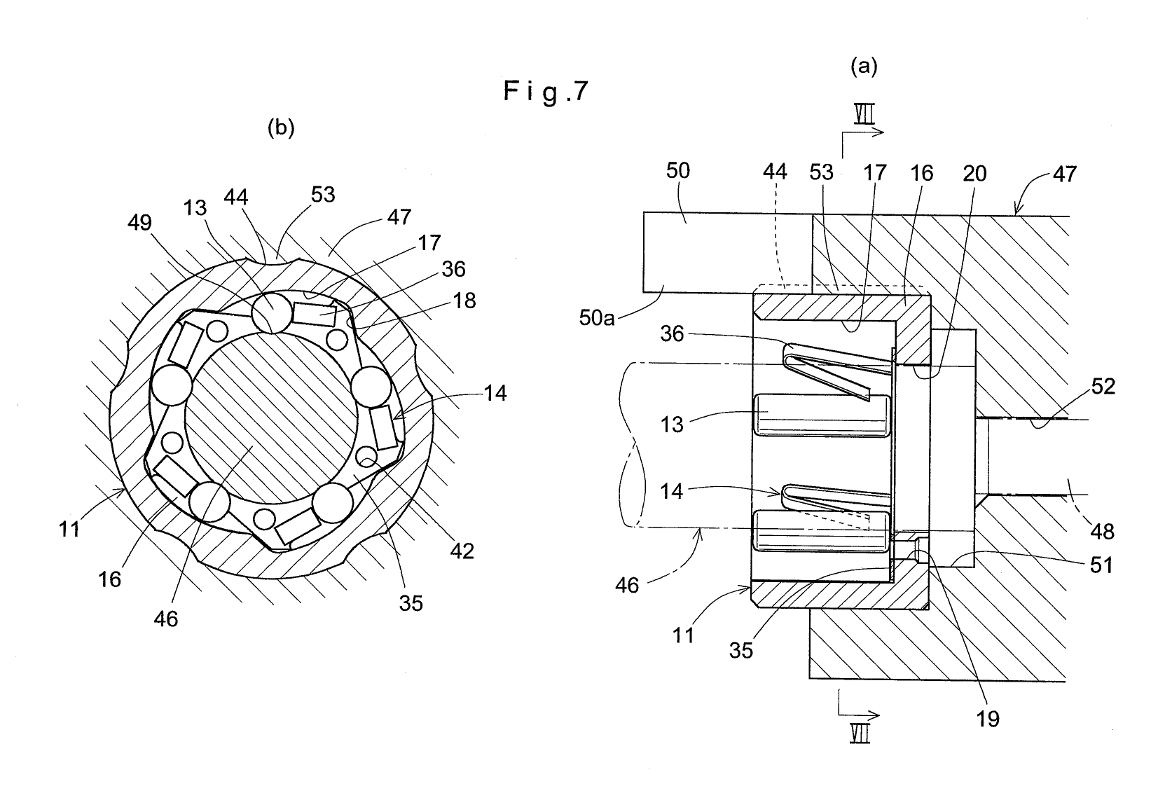

Then as shown in FIGS. 7(a) and 7(b), with the outer race 11 held in position by the pedestal 47, the biasing spring 14 and the rollers 13 are mounted into the outer race 11. In particular, the biasing spring 14 is inserted into the outer race 11 with its annular portion 35 first. At this time, the annular portion 35 is positioned axially and radially by bringing the positioning protrusions 41 on the base portions 40 into contact with the expanded ends of the guide surface portions of the respective pocket bottom surfaces 17, and positioning the cuts 38 so as to extend along the respective positioning portions 18. In this state, the positioning holes 42 align with the respective holes 19 formed in the flange 16. The spring pieces 36 are inserted in the enlarged ends of the respective pockets 24.

Then, the jig rod 46 is inserted into the outer race 11 with its one end first until the engaging portion 48 at the one end is fitted in the engaging hole 52 in the bottom wall of the pedestal 47. In this state, the rollers 13 are inserted between the respective pocket bottom surfaces 17 of the outer race 11 and the corresponding axial grooves 49 of the jig rod 46. Since the jig rod 46 is circumferentially positioned due to the engaging portion 48 of the jig rod 46, which has a D-shaped section, being engaged in the engaging hole 52 of the pedestal, which also has a D-shaped section, once the rollers 13 are inserted between the outer race 11 and the jig rod 46, the circumferential positions of the rollers 13 relative to the respective pocket bottom surfaces 17 are always the same. Thus, as soon as the rollers 13 are inserted into the outer race 11, the rollers are automatically brought into the same position as the one-clutch is in operation. This makes it easier to later mount the retainer 12 into the outer race 11.

Means for circumferentially positioning the jig rod 46 is not limited to the engaging portion 48 and the engaging hole 52, which both have a D-shaped section, but may be e.g. keys or splines. Also, instead of providing such positioning means, after inserting the rollers 13 at any position between the respective pocket bottom surfaces 17 of the outer race 11 and the radially outer surface of the jig rod 46, the jig rod 46 may be turned toward the enlarged end of each pocket bottom surface 17 until the rollers 13 engage in the respective axial grooves 49 and held in this position.

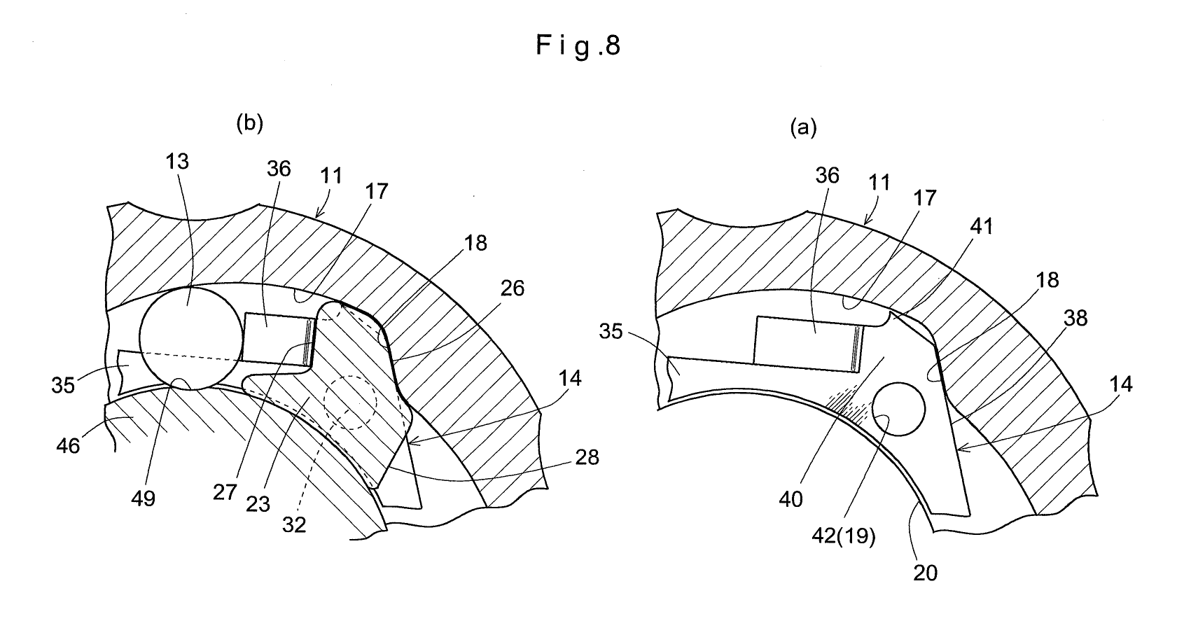

In this state, as shown in FIG. 9, the retainer 12 is inserted into the outer race 11 with its pillars 23 first. At this time, the pillars 23 of the retainer 12 are inserted into the outer race 11 with one of the anti-rotation grooves 45 of the lid 22 of the retainer 12 slid on the radially inner edge 50a of the guide portion 50 of the pedestal 47. Thus, as shown in FIG. 8(b), the pillars 23 are reliably inserted in the position during operation of the clutch, i.e. the position in which their radially outer surfaces 26 abut the enlarged end portions of the respective pocket bottom surfaces 17 and positioning portions 18. In this state, the protrusions 32 of the pillars 23 extend through the respective positioning holes 42 of the biasing spring 14 and inserted through the holes 19 of the outer race 1, with the tips of the protrusions 32 slightly protruding from the holes 19 into the space of the small-diameter hole 51 of the pedestal 47.

As shown in FIGS. 7(a) and 7(b), before the retainer 12 is mounted, the spring pieces 36 of the biasing spring 14 are pressed by the respective rollers 13 and inclined toward the expanded sides of the respective pocket bottom surfaces 17. But since the inclined guide surfaces 33 and 34 are formed at the distal end portions of the respective circumferential end surfaces 27 and 28 of the pillars 23 of the retainer 12 as described above, each pillar 23 is smoothly inserted into a space defined by the corresponding spring piece 36, the outer race 11 and the jig rod 46, thereby pressing and bending the spring piece 36 together with the roller 13 to the position during operation of the clutch, until the pillars 23 reach the bottom of the outer race 11.

Lastly, in the state of FIG. 9, the jig rod 46 and the pedestal 47 are dismounted, and with the inner surface of the lid 22 pressed against the end surface of the outer race 11 at the open end, the protruding ends of the protrusions 32 of the retainer 12 are fused or caulked while heating so that the thermally deformed protruding end of each protrusions 32 fills and adheres to a large-diameter portion 19a of the hole 19, thereby forming a fixing portion 43 (see FIG. 2).

In this assembled state, the retainer 12, which comprises the pillars 23 and the lid 22, which is integral with the pillars, is integrally fixed to the outer race 11 through the fixing portions 43. This stabilizes the attitude of the pillars 23 of the retainer 12, thereby retaining the proper shape of the pockets 24. Also, the behavior of each roller 13 also stabilizes, which is biased by the spring piece 36 toward the narrow end of a wedge-shaped space formed when the roller 13 contacts the shaft 15 and the cam surface of the pocket bottom surface 17 and having a wedge angle δ (see FIG. 1).

With the one-way clutch of Embodiment 1, the retainer 12 is fixed to the outer race 11, with one of the open ends of the outer race 11 closed by its own flange 16 and the other open end closed by the lid 22 of the retainer 12, thus preventing separation of the rollers 13 and the biasing spring 14. The roller restricting portions 29 and 31 prevent separation of the rollers 13 in the radially inward direction. Since the component parts are thus integrally coupled together, it is not necessary to mount the component parts in a casing when assembling the one-way clutch, which makes it possible to handle the clutch component parts only. But they may be mounted in the casing if necessary.

In operation of the one-way clutch, with the outer race 11 stationary, when the shaft 15 rotates in the direction from the narrow toward wide end of each wedge-shaped space (in the direction of the arrow A in FIG. 1), the rollers 13 are moved in this direction and disengage, thus preventing transmission of torque. When the shaft 15 rotates in the opposite direction, the rollers 13 move toward the narrow ends of the respective wedge-shaped spaces and wedge between the outer race and the shaft, thus locking the clutch. Torque is thus transmitted. Torque may also be transmitted from the outer race 11 to the shaft 15 in the same manner.

### DESCRIPTION OF THE NUMERALS

11. Outer race
12. Retainer
13. Roller
14. Biasing spring
15. Shaft
16. Flange
17. Pocket bottom surface
18. Positioning portion
19. Hole
19a Large-diameter portion
20, 21. Radially inner surface
22. Lid
23. Pillar
24. Pocket
25. Radially inner surface
26. Radially outer surface
27. Enlarged end surface
28. Narrow end surface 29, 31. Roller restricting portion
32. Protrusion
33, 34. Guide surface
35. Annular portion
36. Spring piece
37. Hole
38. Cut
39. Raised bent portion
40. Base portion
41. Positioning protrusion
42. Positioning hole
43. Fixing portion
44, 45. Anti-separation groove
46. Jig rod
47. Pedestal
48. Engaged portion
49. Axial groove
50. Guide portion
50a. Radially inner edge
51. Small-diameter hole
52. Engaging hole
53. Rib

1. A one-way clutch comprising an outer race (11) having a plurality of pockets (24) formed on a radially inner surface of the outer race (11), rollers (13) received in the respective pockets (24), a biasing spring (14) biasing the rollers (13), closing means closing open ends of the outer race (11), and a shaft (15) extending through the center of the outer race (11), wherein each pocket (24) has a pocket bottom surface (17) including a cam surface, and wherein the wedge-shaped spaces having a predetermined wedge angle δ are defined between the respective pocket bottom surfaces (17) and the shaft (15), said rollers (13) being biased by the biasing spring (14) toward the narrow ends of the respective wedge-shaped spaces;
characterized in that said closing means comprises a flange (16) radially inwardly extending from one end of the outer race (11), and a lid (22) provided at the other end of the outer race (11);
that each of the pockets (24) is defined by the pocket bottom surface (17) and pillars (23) inserted in the outer race on the respective circumferential sides of the pocket bottom surface (17);
that said pillars (23) have base portions integrally joined to the lid (22), whereby the pillars (23) and the lid (22) form a retainer (12); and
that said retainer (12) is fixed to the outer race (11) by fixing distal ends of the respective pillars (23) to the flange (16).

2. The one-way clutch of claim 1 wherein the pillars (23) have protrusions (32) at the respective distal ends thereof which are inserted in and fixed to holes (19) formed in the flange (16).

3. The one-way clutch of claim 2 wherein each of said holes (19) has a large-diameter portion (19a) at its outer end, and wherein the distal end of the corresponding protrusion (23) is enlarged by heat deformation and fills the large-diameter portion (19a), thereby forming a fixing portion (43) for the retainer (12).

4. The one-way clutch of claim 1 wherein each pocket bottom surface (17) is defined by an eccentric arcuate surface extending from one of five circumferentially equidistantly spaced starting points P1 on the radially inner surface of the outer race (11) to an end point (P2) and having a center (O′) offset from the center (O) of the outer race, wherein the distance between the center (O) of the outer race and the pocket bottom surface (17) gradually increases from the starting point (P1) toward the end point (P2), wherein the portion of each pocket bottom surfaces extending from the starting point (P1) to the end point (P2) serves as a cam surface and also as a radial guide surface of the retainer (12), and
wherein a radially extending shoulder portion of each pocket bottom surface (17) which extends from the end point (P2) to the starting point (P1) of the adjacent pocket bottom surface (17) serves as a circumferential positioning portion (18) for the retainer (12).

5. The one-way clutch of claim 4 wherein the pillars (23) of the retainer (12) have radially outer surfaces (26) that coincide with the respective positioning portions (18) of the outer race (11).

6. The one-way clutch of claim 1 wherein each pillar (23) of the retainer (12) has on one circumferential end surface thereof an enlarged end surface (27) defining the enlarged side of the pocket (24), said enlarged end surface (27) having a distal end portion forming an inclined guide surface (33) inclined such that the pocket (24) expands toward its distal end.

7. The one-way clutch of claim 6 wherein the inclined guide surface (33) at the one circumferential end surface of each pillar (23) of the retainer (12) narrows toward its distal end.

8. The one-way clutch of claim 1 wherein each pillar (23) of the retainer (12) has on the other circumferential end surface thereof a narrow end surface (28) defining the narrow side of the pocket (24) having a distal end portion forming an inclined guide surface (34) inclined such that the pocket (24) expands toward its distal end.

9. The one-way clutch of claim 1 wherein the pair of pillars (23) defining each pocket (24) has roller restricting portions (29 and 31) protruding toward each other along the radially inner surface of the lid (22), the distance between the opposed roller restricting portions (29 and 31) being smaller than the diameter of the rollers (13).

10. The one-way clutch of claim 1 wherein said biasing spring (14) comprises an annular portion (35) and spring pieces (36) corresponding to the respective pockets (24), the spring pieces (36) being formed by cutting and raising peripheral edge portions of the annular portion (35) circumferentially spaced apart from each other at predetermined intervals.

11. The one-way clutch of claim 10 wherein the annular portion (35) of the biasing spring (14) has positioning holes (42) aligned with the respective holes (19) formed in the flange (16).

12. The one-way clutch of claim 11 wherein the protrusions (32) provided at the distal ends of the respective pillars (23) of the retainer (12) are inserted through the respective positioning holes (42) of the biasing spring (14) and the respective holes (19) of the flange (16), and fixed to the respective holes (19) of the flange (16).

13. The one-way clutch of claim 12 wherein in an assembled state in which the protrusions (32) of the pillars (23) are fixed to the respective holes (19) of the flange (16), the distal end portions of the pillars (23) are in abutment with the annular portion (35) of the biasing spring (14), and the lid (22) of the retainer (12) is in abutment with the end surface of the outer race (11) at the other open end thereof.

14. The one-way clutch of claim 1 wherein the radially inner surface (21) of the lid (22) of the retainer (12) and the radially inner surfaces (25) of the pillars (23) of the retainer (12) form a radial bearing for the shaft (15).

15. A method of assembling the one-way clutch of claim 1, characterized in that said method comprises providing a pedestal (47) having a tubular portion into which the outer race (11) can be inserted, said tubular portion having ribs (53) on its radially inner surface that are configured to be fitted in respective anti-rotation grooves (44) formed on the radially outer surface of the outer race (11), inserting the outer race (11) axially into the pedestal (47) with the anti-rotation grooves (44) of the outer race (11) axially aligned with the respective ribs (53) of the pedestal (47), and mounting the biasing spring (14), the rollers (13) and the retainer (12) into the outer race (11).

16. The method of claim 15 further comprising providing jig rod (46) to be inserted through the outer race (11), the jig rod (46) having axial grooves (49) formed on a radially outer surface thereof at positions where the respective rollers (13) are mounted, wherein with the outer race (11) inserted in the pedestal (47) and the biasing spring (14) mounted in the outer race (11), the jig rod (46) is inserted into the pedestal (47) until its one end portion is fitted in an engaging hole (52) formed in the inner surface of a bottom of the pedestal (47) at its central portion, and then the rollers (13) are each inserted between the corresponding pocket bottom surface (17) of the outer race (11) and the corresponding axial groove (49) of the jig rod (46).

17. The method of claim 16 wherein the axial grooves (49) of the jig rod (46) have a concave arcuate section with a radius of curvature equal to the radius of the rollers (13).

18. The method of claim 16 wherein positioning means for circumferentially positioning the jig rod (46) is provided at the one end portion of the jig rod (46) and the pedestal (47), wherein said positioning means keeps constant circumferential positions of the rollers (13) relative to the respective pocket bottom surfaces (17).

19. The method of claim 15 wherein the tubular portion of the pedestal (47) has a guide portion (50) axially extending from the open end thereof and configured to engage in one of anti-rotation grooves (44) formed on the radially outer surface of the lid (22) of the retainer (12), thereby axially guiding the retainer, and wherein the pillars (23) of the retainer (12) are inserted into the outer race (11) while keeping one of the anti-rotation grooves (45) of the lid (22) in sliding contact with the guide portion (50) of the pedestal (47).
